(19) United States
(12) Patent Application Publication
(10) Pub. No.: US 2010/0288013 A1
(43) Pub. Date: Nov. 18, 2010

(54) METHOD AND DEVICE FOR CONDUCTING CRASH-SLED TESTS

(75) Inventors: Andreas Moser, Linz (AT); Manfred Hofinger, Linz (AT); Hermann Steffan, Linz (AT)

Correspondence Address: DAY PITNEY LLP;ACCOUNT: ILLINOIS TOOL WORKS INC., 7 TIMES SQUARE, NEW YORK, NY, 10036-7311, US

(73) Assignee: ILLINOIS TOOL WORKS INC., Glenview, IL (US)

(21) Appl. No.: 12/676,195

(22) PCT Filed: Aug. 22, 2008
(86) PCT No.: PCT/US2008/010010

§ 371 Date: May 25, 2010

(30) Foreign Application Priority Data
Sep. 7, 2007 (DE) 10 2007 042 775.3

(51) Int. Cl. G01M 10/00

(52) U.S. Cl. 73/12.04

(57) ABSTRACT

Method for conducting crash sled tests, in particular for simulating the impact of a motor vehicle on an obstacle, whereby the deceleration forces of a real collision are simulated by accelerating a crash sled in a manner corresponding to the real deceleration curve, and whereby, for an improved simulation of the movement of the test object upon impact, the pitching motion in a collision is additionally simulated by moving the test object in the vertical direction. Also, a device for applying said method.

This invention relates to a method for conducting crash-sled tests, in particular for simulating the frontal impact of a motor vehicle on an obstacle, whereby the deceleration forces of a real collision are simulated by accelerating a crash sled at a rate corresponding to the real deceleration curve. The invention also relates to a device for employing said method.

For investigating the acceleration gradients in accidents without having to destroy an entire vehicle, so-called crash sled tests have been conducted in which, instead of a collision of the test object with an obstacle, the deceleration in a real crash test is simulated by accelerating the test object. Specifically, the acceleration forces that act on the payload of the vehicle in the collision with an obstacle are directly applied on the test object through an acceleration of the crash sled. This permits highly precise simulation of real deceleration curves.

An example of a method of the type mentioned is described in EP 1 188 039 B1. In applying that prior-art method, the crash sled is subjected to a force in the direction of acceleration which is greater than the force needed for an acceleration corresponding to the real deceleration gradient, while for attaining the desired acceleration curve a braking power in the opposite direction of acceleration is applied on the crash sled or on the device driving it, the magnitude of which is such that the resulting force accelerates the sled along the desired acceleration curve. This permits highly precise simulation of the acceleration curve.

It is the objective of this present invention to introduce an improved method of the type referred to above. In particular, it is aimed at an even better real-crash simulation of the forces acting on the test object.

The method described achieves this objective by additionally simulating the pitching motion upon impact in that the test object is moved in an upward direction.

The stated objective is also achieved by means of a device as specified in claim 7.

By additionally simulating the pitching motion upon impact of the test object on an obstacle, it is possible to replicate the forces thus generated, making the simulation of a real collision even more accurate.

For a particularly good simulation of the pitching motion encountered in real collisions, the test object is preferably moved at its front and/or rear end. In addition and for the same purpose, the test object is preferably raised and/or lowered. This allows virtually all forces generated by the pitching motion to be simulated, especially when, in an enhanced implementation of the invention, these movements are individually controlled independently of one another.

A particularly precise simulation of the forces engendered by the pitching motion is achievable during the test by subjecting the test object to an acceleration force in the pitching direction which force is stronger than the force needed for an acceleration that would match the real pitching motion, and by generating the desired motion through the application of a braking power that counteracts the acceleration and is strong enough for the resulting force to lead to the desired pitching motion. This means that, preferably, the principle applied in generating the pitching motion is the same as that employed for the axial movement of the crash sled described in EP 1 188 039 B1. In that context, the braking power is preferably controlled as a function of the measured, real pitching motion, which can yield still better results.

A device for employing the method according to the invention encompasses a sled on which the test object can be mounted, as well as means serving to accelerate the sled in a manner corresponding to the real deceleration curve, as well as a sled-mounted mechanism by means of which the test object can be moved in the vertical direction. Preferably, the test object can be moved in the vertical direction at its front and/or rear end. Preferably again, the test object as such can be raised and/or lowered while the front end and the rear end can be individually moved independently of each other.

In another implementation of the invention, the sled is equipped with actuators for the movement of the test object, which has been found to be especially useful.

The actuators are preferably designed to move swivel levers which translate a movement in the plane of the sled into a vertical movement. Advantageously, the actuators can thus be positioned in the longitudinal direction of the sled, which allows the forces bearing on the actuators as the sled is accelerated to be held at a relatively low level.

As another advantageous feature, the actuator that raises and lowers the rearward end is bracket-mounted at the front end of the sled, while the actuator for raising and lowering the front end is mounted at the back of the sled. This allows essentially the entire length of the sled to be utilized for the placement of actuators.

In another configuration according to the invention, each actuator moves a length-adjustable lever, making it possible to adjust the initial inclination of the test object.

To achieve a particularly good simulation of the pitching motion, the actuators in one configuration of the invention feature a compression chamber delimited in volume by a piston which by way of a push rod acts on the test object, a compressor that generates the necessary pressure in the compression chamber, as well as a braking mechanism that acts on the push rod or the test object itself. The braking mechanism can thus control the pitching motion with particularly fast response and corresponding accuracy.

Another configuration according to the invention incorporates elements by means of which the braking power is adjustable as a function of the measured real pitching motion. The real pitching motion can thus be simulated even more accurately.

In a particularly preferred design implementation of the invention, an auxiliary platform is positioned on the sled, which is height-adjustable in relation to the sled and on which the test object can be mounted. This greatly facilitates the placement of the test object on the device according to the invention as well as the adjustment of its desired initial position.

As another especially advantageous feature, the platform is linked to the sled via a swivel lever which is so installed that on both the sled and on the platform it can be tilted on horizontal transverse swivel pins that are axially offset relative to each other in the longitudinal direction.

Advantageously, the swivel lever permits the transfer of the forces generated during the acceleration of the crash sled, while the longitudinally offset transverse swivel pins permit any desired pitching motion of the platform and thus of the test object mounted on it.

An implementation example is illustrated in the attached drawing and described below. In the only illustration,

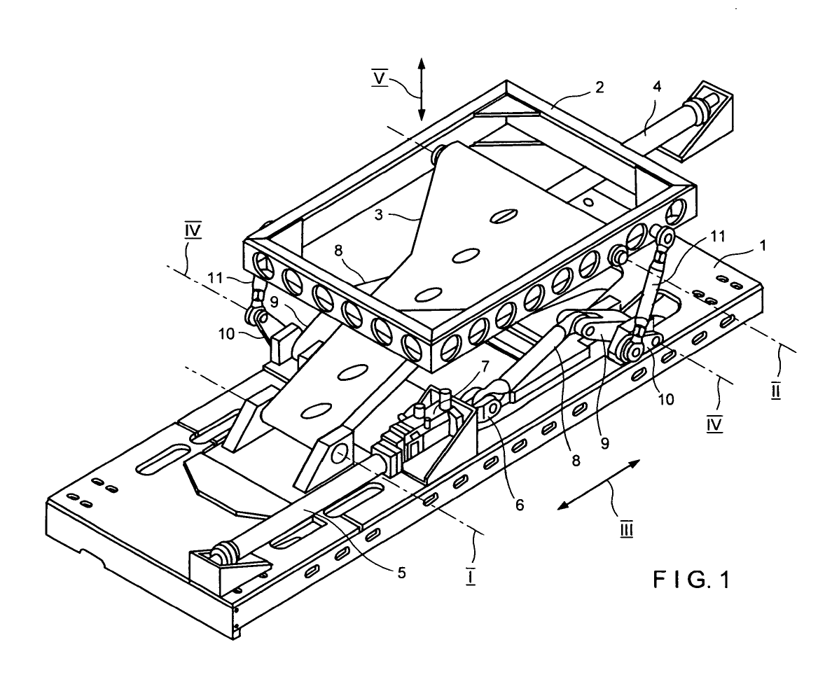

FIG. 1 is a perspective view of a crash sled according to the invention for the additional simulation of pitching motions.

Illustrated in FIG. 1 is the upper section of a conventional crash sled 1 without its carriage and drive system. An auxiliary platform 2 is positioned on sled 1 for supporting a test object, not illustrated. Platform 2 is linked to sled 1 via a swivel lever 3 which, pivoting on a horizontal swivel pin along the transverse axis I, can be tilted relative to sled 1 and, on a horizontal swivel pin along the transverse axis II, relative to platform 2. The two horizontal transverse swivel pins I and II are axially offset in the longitudinal direction III of sled 1. In this fashion, platform 2 can be arbitrarily height-adjusted relative to sled 1 as indicated by the arrow V. Altogether, platform 2 can thus be raised and lowered in front and in back in relation to sled 1, and as a whole it can be height-adjusted relative to sled 1.

Two actuators 4 and 5 mounted on sled 1 serve to adjust the position of platform 2 relative to sled 1. The two actuators 4 and 5 are each equipped with a compression chamber, its volume delimited by a piston that moves a push rod 6. Also provided is a compressor, not illustrated, for generating the necessary pressure in the compression chamber of the respective actuator 4 and 5. A braking system 7 is designed to counteract, in the manner described below, the acceleration force generated by the pressure in the compression chamber and acting on the push rod 6.

As shown, one end of the first actuator 4 is bracket-mounted at the front end of sled 1, while one end of the second actuator 5 is bracket-mounted at the rearward end of sled 1. It will be evident that this arrangement leaves the full length of sled 1 available for optimal utilization. The push rods 6 of the actuators 4 and 5 move the swivel levers 8, 9 which translates the linear movement of the respective push rod 6 parallel to the top plane of sled 1 into a rotational movement of another lever 10 around a horizontal transverse swivel pin IV. Connected in each case between the free end of that lever 10 and the platform 2 is a length-adjustable rod 11. This permits selective adjustment of the initial position and inclination of platform 2, as well as the initial angle of rotation of swivel levers 8 and 9.

The pitching motion of a test object colliding with an obstacle is simulated in that, via the compressor, a pressure level is established in the compression chamber of the respective actuators 4, 5 that permits maximum acceleration of the push rod 6. The actual acceleration of push rod 6 for the desired pitching motion is selectively controlled via the braking system 7. The actual pitching motion of platform 2 can be measured and used for controlling that pitching motion. In this fashion it is possible to optimize the simulation of the pitching motion of the test object as it would result from a real impact.

Using two actuators 4, 5 allows the up and down movement of the front end of the test object to be adjusted independently of the up and down movement of its rear end. By way of swivel lever 3 with the axially offset swivel pins 1, 2, the acceleration forces generated in the crash test can be transferred from sled 1 to auxiliary platform 2. The swivel levers 8, 9 allow the actuators 4, 5 to be positioned in the longitudinal direction of the sled, which permits a good transfer of the forces generated through the acceleration of sled 1.

### LIST OF REFERENCE NUMBERS

1 sled

2 platform

3 swivel lever

4 actuator

5 actuator

6 push rod

7 braking system

8 swivel lever

9 swivel lever

10 lever

11 rod

I swivel pin

II swivel pin

III direction of movement by I

IV swivel pin

V vertical direction

1. Method for conducting crash sled tests, in particular for simulating the impact of a motor vehicle on an obstacle, whereby the deceleration forces of a real collision are simulated by accelerating a crash sled in a manner corresponding to the real deceleration curve, characterized in that, additionally, the pitching motion upon impact is simulated by moving the test object in the vertical direction.

2. Method as in claim 1, characterized in that the test object is moved at its front and/or rear end.

3. Method as in claim 1, characterized in that the test object is raised and/or lowered.

4. Method as in claim 2, characterized in that the movement of the front end of the test object is controlled independently of the movement of its rear end.

5. Method as in claim 1 characterized in that, during the test, the test object is subjected to an acceleration force in the pitching direction which force is greater than the force needed for an acceleration corresponding to the real pitching motion, and that for achieving the desired pitching motion a braking power is applied that counteracts the acceleration and is strong enough for the resulting force to lead to the desired pitching motion.

6. Method as in claim 5, characterized in that the braking power is controlled as a function of the measured real pitching motion.

7. Device for applying the method according to claim 1, with a sled (1) on which the test object can be mounted and with means for accelerating sled (1) in a manner corresponding to the real deceleration curve, characterized in that sled (1) is provided with additional elements (4, 5) by means of which the test object can be moved in the vertical direction.

8. Device as in claim 7, characterized in that the front and/or rear end of the test object can be moved in the vertical direction.

9. Device as in claim 7, characterized in that the test object can be raised and/or lowered.

10. Device as in claim 7, characterized in that the front-end and rear-end motion of the test object can be individually controlled independently of each other.

11. Device as in claim 7, characterized in that for the movement of the test object relative to sled (1), sled (1) is provided with actuators (4, 5).

12. Device as in claim 11, characterized in that the actuators (4, 5) act on swivel levers (8, 9) by way of which a movement in the longitudinal direction (III) of sled (1) is translated into a movement in the vertical direction (V).

13. Device as in claim 11, characterized in that the actuator (4) for the front-end up and down movement is bracket-mounted in the rear of sled (1), and the actuator for the rear-end up and down movement is bracket-mounted in the front of sled (1).

14. Device as in claim 11, characterized in that each actuator (4, 5) acts on a length-adjustable rod (11).

15. Device as in claim 11, characterized in that each actuator (4, 5) comprises a compression chamber whose volume is delimited by a piston which, by way of a push rod (6), acts on the test object, as well as a compressor for generating the necessary pressure in the compression chamber, and a braking system (7) that acts on the test object or on the push rod (6).

16. Device as in claim 15, characterized in that elements are provided by means of which the braking power can be controlled as a function of the measured real pitching motion.

17. Device as in claim 7, characterized in that mounted on sled (1), is an auxiliary platform (2) that is height-adjustable relative to sled (1) and on which the test object can be mounted.

18. Device as in claim 17, characterized in that platform (2) is linked to sled (1) via a swivel lever (3) that is pivot-mounted on sled (1) and on platform (2), respectively, via horizontal transverse swivel pins (I, II) which are axially offset in the longitudinal direction (III) of the sled.
